(19) United States
(12) Patent Application Publication
(10) Pub. No.: US 2011/0095682 A1
(43) Pub. Date: Apr. 28, 2011

(54) PLASMA DISPLAY DEVICE

(76) Inventor: Yongkyoung Cho, Gumi-si (KR)

(21) Appl. No.: 12/999,741

(22) PCT Filed: Nov. 5, 2009
(86) PCT No.: PCT/KR2009/006477

§ 371 Date: Dec. 17, 2010

(30) Foreign Application Priority Data
May 1, 2009 (KR) 10-2009-0038685

(51) Int. Cl. H01J 17/49

(52) U.S. Cl. 313/582

(57) ABSTRACT

A plasma display device is provided. A plurality of electrodes electrically coming into contact with a connecting member on a pad region of a plasma display panel are sloped having predetermined gradients, and thus the electrodes can easily come into contact with the connecting member and the contact area of the electrodes and the connecting member can be increased. Further, a pad electrode pattern of the connecting member is also sloped according to the plurality of electrodes formed having gradients, and thus the size and area of the connecting member can be reduced and the manufacturing cost can be decreased.

### TECHNICAL FIELD

The present invention relates to a plasma display device, and more particularly, to a plasma display device in which the structure of a plurality of electrodes formed on a pad region surrounding an effective area displaying an image is improved to easily extend the contact area of the plurality of electrodes and a connecting member electrically coming into contact with the plurality of electrodes on the pad region.

### BACKGROUND ART

A plasma display device includes a panel constructed in such a manner that a plurality of discharge cells are formed between a rear substrate on which a barrier is formed and a front substrate opposite to the rear substrate. The plasma display device selectively discharges the plurality of discharge cells according to an input image signal such that vacuum ultraviolet rays generated according to the discharge make a fluorescent material radiate to thereby display an image.

Generally, a plasma display panel applies a predetermined voltage to electrodes arranged in a discharge space to generate discharge such that plasma generated during gas discharge excites a fluorescent material to display an image including characters or graphic. The size of the plasma display panel can be easily increased and the weight and thickness thereof can be easily decreased. Further, the plasma display panel can provide a wide viewing angle and achieve full-color display and high luminance.

The plasma display device includes a driving circuit generating signals for driving the plasma display panel and connecting members for electrically connecting the panel and the driving circuit to supply the driving signals to a plurality of electrodes formed on the panel.

Recently, studies on a technique of extending the contact area of the plurality of electrodes and the connecting members of the plasma display device have been carried out.

### DISCLOSURE OF INVENTION

### Solution to Problem

According to an aspect of the present invention, there is provided a plasma display device comprising a plasma display panel on which a plurality of electrodes are formed, wherein at least one of the plurality of electrodes includes a line electrode, a connecting electrode and a pad electrode, and the line electrode, the connecting electrode and the pad electrode have different gradients.

According to another aspect of the present invention, there is provided a plasma display device comprising a plasma display panel on which a plurality of electrodes are formed, wherein the plurality of electrodes respectively include line electrodes, connecting electrodes and pad electrodes, and pad electrodes of first and second electrodes among the plurality of electrodes have different gradients.

According to another aspect of the present invention, there is provided a plasma display device comprising a plasma display panel on which a plurality of electrodes are formed, wherein at least one of the plurality of electrodes includes a line electrode, a connecting electrode and a pad electrode, and the length of the pad electrode is greater than the width of a contact region connected to a connecting member.

### Advantageous Effects of Invention

In the plasma display device according to the present invention, a plurality of electrodes electrically coming into contact with a connecting member on a pad region of the plasma display panel are sloped having predetermined gradients, and thus the electrodes can easily come into contact with the connecting member and the contact area of the electrodes and the connecting member can be increased. Further, a pad electrode pattern of the connecting member is also sloped according to the plurality of electrodes formed having gradients, and thus the size and area of the connecting member can be reduced and the manufacturing cost can be decreased.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a plasma display panel according to an embodiment of the present invention;

FIG. 2 is a view illustrating arrangement of electrodes of a plasma display panel;

FIG. 3 is a timing diagram for explaining a method of dividing a single frame into a plurality of subfields to time-division-drive a plasma display panel according to an embodiment of the present invention;

FIG. 4 is a timing diagram showing driving signals for driving a plasma display panel;

FIG. 5 is a perspective view roughly showing the structure of a plasma display device according to the present invention;

FIG. 6 is a front view showing an upper substrate of the plasma display device illustrated in FIG. 5 according to an embodiment of the present invention;

FIG. 7 is a plan view showing a region ‘A’ illustrated in FIG. 6;

FIG. 8 is a view showing a configuration of a connecting member in contact with scan electrodes illustrated in FIG. 7 according to an embodiment of the present invention; and

FIGS. 9, 10 and 11 illustrate a plasma display device according to embodiments of the present invention.

### BEST MODE FOR CARRYING OUT THE INVENTION

Hereinafter, an embodiment of the present invention will be described below with reference to the accompanying drawings.

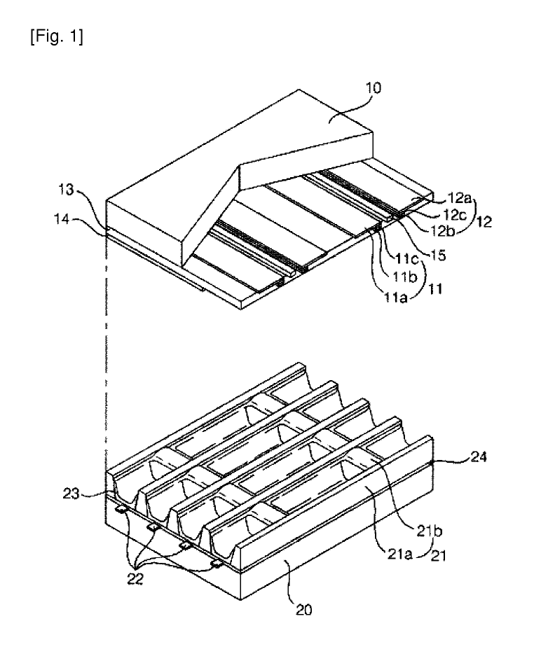

FIG. 1 is a perspective view showing the structure of a plasma display panel according to an embodiment of the present invention.

Referring to FIG. 1, the plasma display panel includes sustain electrode pairs each of which consists of a scan electrode 11 and a sustain electrode 12 formed on an upper substrate 10 and address electrodes 22 formed on a lower substrate 20.

The sustain electrode pairs 11 and 12 respectively include transparent electrodes 1 la and 12a generally formed of indium-tin-oxide (ITO) and bus electrodes 11b and 12b. The bus electrodes 11b and 12b may be formed of a metal such as Ag or Cr or formed in a laminated structure of Cr/Cu/Cr or Cr/Al/Cr. The bus electrodes 11b and 12b are respectively formed on the transparent electrodes 11a and 12a and reduce voltage drop caused by the transparent electrodes 11a and 12a having high resistance.

In an embodiment of the present invention, the sustain electrode pairs 11 and 12 may be composed of only the bus electrodes 11b and 12b without having the transparent electrodes 11a and 12a. This structure can decrease the manufacturing cost of the plasma display panel because the transparent electrodes 11a and 12a are not used. In this structure, the bus electrodes 11b and 12b can be formed of various materials such as a photosensitive material in addition to the aforementioned materials.

A black matrix 15 having a light-shielding function that absorbs external light generated outside the upper substrate 10 to reduce reflection and a function of improving the purity and contrast of the upper substrate 10 is arranged between the scan electrode 11 and the sustain electrode 12.

In the current embodiment of the invention, the black matrix 15 is formed on the upper substrate 10 and may include a first black matrix 15 superposed on a barrier 21 and a second black matrix 11c and 12c formed between the transparent electrodes 11a and 12a and the bus electrodes 11b and 12b. Here, the first black matrix 15 and the second black matrix 11c and 12c that is also referred to as a black layer or a black electrode layer may be simultaneously formed and physically connected to each other. Otherwise, the first black matrix 15 and the second black matrix 11c and 12c may not be simultaneously formed and physically connected to each other.

The first black matrix 15 and the second black matrix 11c and 12c may be formed of the same material when they are physically connected to each other and formed of different materials when they are physically separated from each other.

An upper dielectric layer 13 and a protective layer 14 are sequentially formed on the upper substrate 10 on which the scan electrode 11 and the sustain electrode 12 are formed in parallel. The upper dielectric layer 13 has charged particles accumulated therein, which are generated according to discharge, and protects the sustain electrode pairs 11 and 12. The protective layer 14 protects the upper dielectric layer 13 from sputtering of charged particles generated during gas discharge and increases secondary electron emission efficiency.

Further, the protective layer 14 may be formed of MgO or Si—MgO. Here, the content of Si added to the protective layer 14 may be in the range of 60 PPM to 200 PPM based on weight percent.

The address electrodes 22 intersect the scan electrode 11 and the sustain electrode 12. Further, a lower dielectric layer 23 and the barrier 21 are formed on the lower substrate 20 on which the address electrodes 22 are formed.

In addition, a fluorescent layer 23 is formed on the surfaces of the lower dielectric layer 24 and the barrier 21. The barrier 21 includes vertical parts 21a and horizontal parts 21b arranged in an intersecting manner, physically segments a discharge space into discharge cells and prevents ultraviolet rays and visible rays generated due to discharge from leaking to neighboring discharge cells.

In an embodiment of the invention, the barrier 21 can have various structures other than the structure illustrated in FIG. 1. For example, a differential barrier structure in which the vertical parts 21a and the horizontal parts 21b have different heights, a channel type barrier structure in which a channel that can be used as an exhaust path is formed in at least one of the vertical parts 21a and the horizontal parts 21b, and a hollow type barrier structure in which a hollow is formed in at least one of the vertical parts 21a and the horizontal parts 21b can be used as the structure of the barrier 21. Here, it is preferable that the horizontal parts 21b are higher than the vertical parts 21a in the differential barrier structure, the channel is formed in the horizontal parts 21b in the channel type barrier structure and the hollow is formed in the horizontal parts 21b in the hollow type barrier structure.

In the current embodiment of the invention, R, G and B discharge cells are arranged on the same line. However, the R, G and B discharge cells may be arranged in different forms. For example, the R, G and B discharge cells may be arranged in a triangular shape, which is a delta type. Further, the R, G and B discharge cells may have various polygonal shapes such as a square, a pentagon and a hexagon.

The fluorescent layer 23 radiates according to ultraviolet rays generated during gas discharge to emit one of red, green and blue visible lights. An inert mixed gas for discharge, such as He+Xe, Ne+Xe and He+Ne+Xe, is injected into the discharge space between the upper and lower substrates 10 and 20 and the barrier 21.

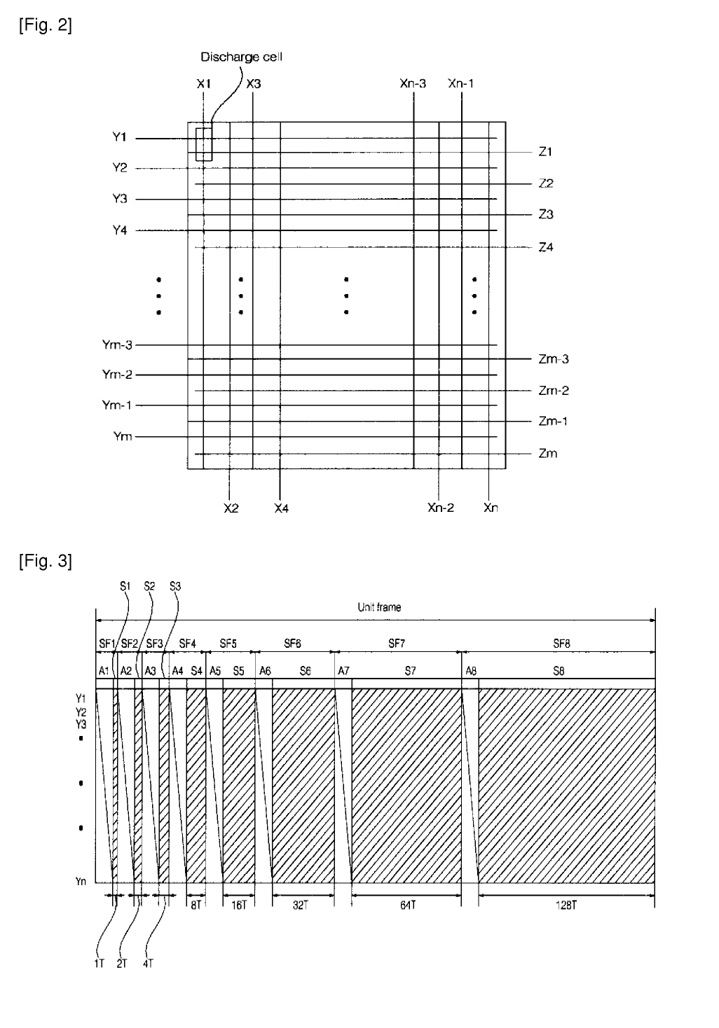

FIG. 2 is a view illustrating arrangement of electrodes of a plasma display panel.

Referring to FIG. 2, a plurality of discharge cells constructing the plasma display panel may be arranged in a matrix form. The plurality of discharge cells are respectively formed at intersections of scan electrode lines Y1 through Ym, sustain electrode lines Z1 through Zm and address electrode lines X1 through Xn. The scan electrode lines Y1 through Ym can be sequentially or simultaneously driven and the sustain electrode lines Z1 through Zm can be simultaneously driven. The address electrode lines X1 through Xn can be divided into odd-numbered lines and even-numbered lines and driven or sequentially driven.

The arrangement of electrodes, illustrated in FIG. 2, is exemplary and the electrode arrangement and driving method of the plasma display panel are not limited thereto. For example, a dual scan method that simultaneously scans two scan electrode lines among the scan electrode lines Y1 through Ym can be applied to the plasma display panel according to the present invention. Further, the address electrode lines X1 through Xn can be divided into left and right parts or upper and lower parts based on the center of the panel and driven.

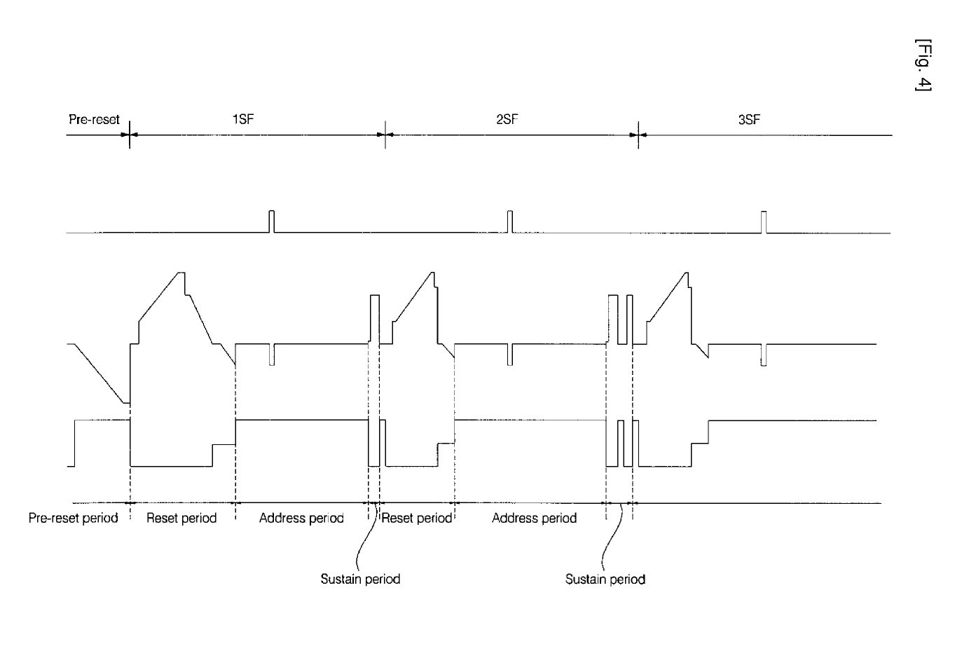

FIG. 3 is a timing diagram for explaining a method of dividing a single frame into a plurality of subfields to time-division-drive the plasma display panel according to an embodiment of the present invention.

A unit frame can be segmented into a predetermined number of subfields, for example, eight subfields SF1 through SF8, to achieve time division gradation display. Further, the subfields SF1 through SF8 are respectively divided into reset periods (not shown), address periods A1 through A8 and sustain periods S1 through S8.

In the current embodiment of the invention, the reset period may be omitted from at least one of the plurality of subfields. For example, the reset period may exist only in the initial subfield or only in an intermediate subfield.

In the address periods A1 through A8, a display data signal is applied to address electrodes X and scan pulses are sequentially applied to scan electrodes Y.

In the sustain periods S1 through S8, a sustain pulse is alternately applied to the scan electrodes Y and sustain electrodes Z, and thus sustain discharge occurs in discharge cells in which wall charges are generated during the address periods A1 through A8.

The luminance of the plasma display panel is proportional to the number of sustain discharge pulses in the sustain discharge periods S1 through S8, included in the unit frame. If a single frame forming a signal image is represented by eight subfields and 256 gray-scales, 1, 2, 4, 8, 16, 32, 64 and 128 sustain pulses may be respectively allocated to the eight subfields. To obtain luminance corresponding to 133 gray-scales, cells are addressed to generate sustain discharge during first, third and eighth subfield periods.

The number of sustain discharges allocated to each subfield can be variably determined based on weights of subfields according to automatic power control (APC) stage. That is, although FIG. 3 illustrates a case that a single frame is divided into eight subfields, the present invention is not limited thereto and the number of subfields forming a single frame may be varied according to design specification. For instance, a single frame can be divided into more than eight subfields, for example, 12 or 16 subfields to drive the plasma display panel.

Further, the number of sustain discharges allocated to each subfield can be variably changed in consideration of gamma characteristic or panel property. For example, gradation allocate to the fourth subfield can be reduced from 8 to 6 and gradation allocated to the sixth subfield can be increased from 32 to 64.

FIG. 4 is a timing diagram showing driving signals for driving the plasma display panel according to an embodiment of the present invention.

Each subfield can include a pre-reset period for forming positive wall charges on the scan electrodes Y and forming negative wall charges on the sustain electrodes Z, a reset period for initializing all the discharge cells of the plasma display panel by using distribution of the wall charges formed during the pre-reset period, an address period for selecting discharge cells, and a sustain period for sustaining discharge of the selected discharge cells.

The reset period includes a setup period and a setdown period. During the setup period, a ramp-up waveform is simultaneously applied to all the scan electrodes Y to generate minute discharge in all the discharge cells, and thus wall charges are generated. During the setdown period, a ramp-down waveform that falls at a positive voltage lower than the peak voltage of the ramp-up waveform is simultaneously applied to all the scan electrodes Y to generate erase discharge in all the discharge cells, and thus unnecessary charges among the wall charges generated according to setup discharge and space charges.

In the address period, a scan signal having a negative scan voltage Vsc is sequentially applied to the scan electrodes Y and, at the same time, a positive data signal is applied to the address electrodes X. Address discharge occurs according to a voltage difference between the scan signal and the data signal and a wall voltage generated during the reset period to select cells. To improve the efficiency of address discharge, a sustain bias voltage Vzb is applied to the sustain electrodes Z.

During the address period, the scan electrodes Y may be divided into at least two groups and scan signals may be sequentially supplied to the respective groups. Further, each of the groups may be divided into at least two sub-groups and scan signals may be sequentially supplied to the respective sub-groups. For example, the scan electrodes Y may be divided into a first group and a second group, scan signals may be sequentially supplied to scan electrodes belonging to the first group, and then scan signals may be sequentially supplied to scan electrodes belonging to the second group.

In an embodiment of the present invention, the plurality of scan electrodes Y may be divided into a first group including even-numbered scan electrodes and a second group including odd-numbered scan electrodes according to positions of the scan electrodes on the panel. In another embodiment of the present invention, the scan electrodes Y may be divided into a first group including scan electrodes located in the upper part of the panel and a second group including scan electrodes located in the lower part of the panel based on the center of the panel.

The scan electrodes belonging to the first group may be divided into a first sub-group having even-numbered scan electrodes and a second sub-group having odd-numbered scan electrodes or divided into a first group including scan electrodes located in the upper part of the first group and a second sub-group including scan electrodes located in the lower part of the first group based on the center of the first group.

In the sustain period, sustain pulse signals having a sustain voltage Vs are alternately applied to the scan electrodes and the sustain electrodes to generate sustain discharge in the form of surface discharge between neighboring scan electrode and sustain electrode.

The first or last sustain pulse signal among the sustain pulse signals alternately applied to the scan electrodes and the sustain electrodes during the sustain period may have a width greater than those of the other sustain pulse signals.

An erase period for erasing wall charges left on scan electrodes or sustain electrodes of on cells selected in the address period by generating weak discharge after the sustain discharge occurs may follow the sustain period.

The erase period may be included in all the subfields or in some of the subfields. It is preferable to apply an erase signal for the weak discharge to an electrode to which the last sustain pulse signal is not applied during the sustain period.

The erase signal may use a ramp signal, a low-voltage wide pulse, a high-voltage narrow pulse, an exponential signal or a half-sinusoidal pulse. Further, a plurality of pulses may be sequentially applied to the scan electrodes or the sustain electrodes to generate the weak discharge.

FIG. 4 illustrates exemplary signals for driving the plasma display panel according to the present invention and the present invention is not limited thereto. For example, the pre-reset period may be omitted, polarities and voltage levels of the driving signals shown in FIG. 4 may be changed if required, and the erase signal for erasing wall charges may be applied to the sustain electrodes after the sustain discharge is completed. Further, the sustain pulse signals may be applied to only one of the scan electrodes Y and the sustain electrodes Z to achieve a single sustain driving operation that causes sustain discharge.

The operation of the plasma display panel may be divided into a power on sequence period and a normal operation period and driving signals provided during the power on sequence period and the normal operation period may have the same waveform or different waveforms if required.

That is, when the plasma display device is powered on, any image is not displayed on the plasma display panel and a power on sequence for preparing a normal operation of the plasma display panel is performed for a predetermined period of time or until a driving voltage supplied to the panel reaches a normal level. Then, an image is displayed on the plasma display panel according to driving signals supplied to the panel during the normal operation period.

Further, even before power supply to the plasma display device is cut, a power off sequence similar to the power on sequence may exist in order to smoothly end power supply to a driving circuit or the panel.

For instance, a display enable signal has a low level corresponding to a value “0” and thus a data signal is not applied to the panel for a predetermined time after power is supplied to the plasma display device. Accordingly, any image is not displayed on the plasma display panel. After a lapse of the predetermined time, the display enable signal has a high level corresponding to “1” and thus the data signal is applied to the panel and an image is displayed on the panel. Moreover, the display enable signal has a low level corresponding to “0” for a predetermined time before power supply to the plasma display device is ended, and thus any image is not displayed on the panel.

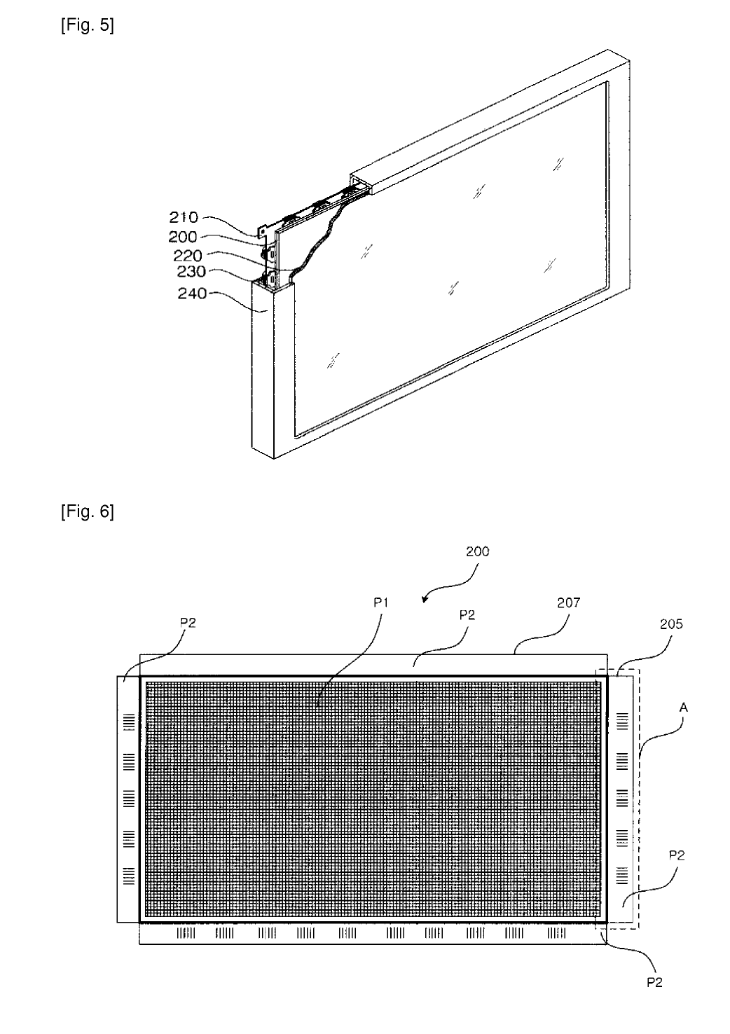

FIG. 5 is a perspective view showing the structure of a plasma display device according to an embodiment of the present invention.

Referring to FIG. 5, the plasma display device may include a plasma display panel 200, a heat sink 210, a filter 220, a back cover 230 and a bezel 240. The heat sink 210 is attached to the backside of the plasma display panel 200 to radiate heat generated from the plasma display panel 200. Further, a printed circuit board (PCB) on which a driver for driving the plasma display panel 200 is mounted is located on the backside of the heat sink 210 and fixed to the heat sink 210.

Specifically, the PCB is connected to a plurality of driving integrated circuits (referred to as “driver ICs” for supplying driving signals to the plasma display panel 200 and the PCB and the plasma display panel 200 may be connected to each other through a connecting member, that is, a flexible printed circuit (FPC).

The filter 220 is located in front of the plasma display panel 200, shields electro-magnetic interference (EMI) and prevents external light from reflecting.

The back cover 230 envelops the backside of the plasma display panel 200. The bezel 240 is combined with the back cover 230 and protruded from the front side of the plasma display device to support the filter 220 while surrounding parts of the edge of the filter 220.

Though the plasma display device includes the filter 220 in the current embodiment of the invention, the filter 220 may be omitted. That is, an EMI pattern instead of the filter 220 may be formed on the plasma display panel 200 to shield EMI.

FIG. 6 is a front view showing an upper substrate 205 of the plasma display device according to an embodiment of the present invention. FIG. 6 shows the front side of the plasma display panel illustrated in FIG. 5.

Referring to FIG. 6, the plasma display panel 200 includes the upper substrate 205 on which a plurality of electrodes (not shown) are formed and a lower substrate 207, which are bonded to each other having a predetermined gap between them. Here, the plasma display panel 200 includes an effective area P1 displaying an image and a marginal area other than the effective area P1. The marginal area is referred to as a pad region P2 hereinafter because the marginal area includes the pad region.

Here, the pad region P2 is covered by the bezel (not shown) and electrically comes into contact with the plurality of electrodes (not shown) formed on the upper substrate 205 and a plurality of pad electrodes (not shown) included in a connecting member (not shown). Though FIG. 6 illustrates that the pad region P2 is located at the left and right edges of the upper substrate 205, the pad region P2 can be formed at the top and bottom edges of the upper substrate and the present invention is not limited thereto.

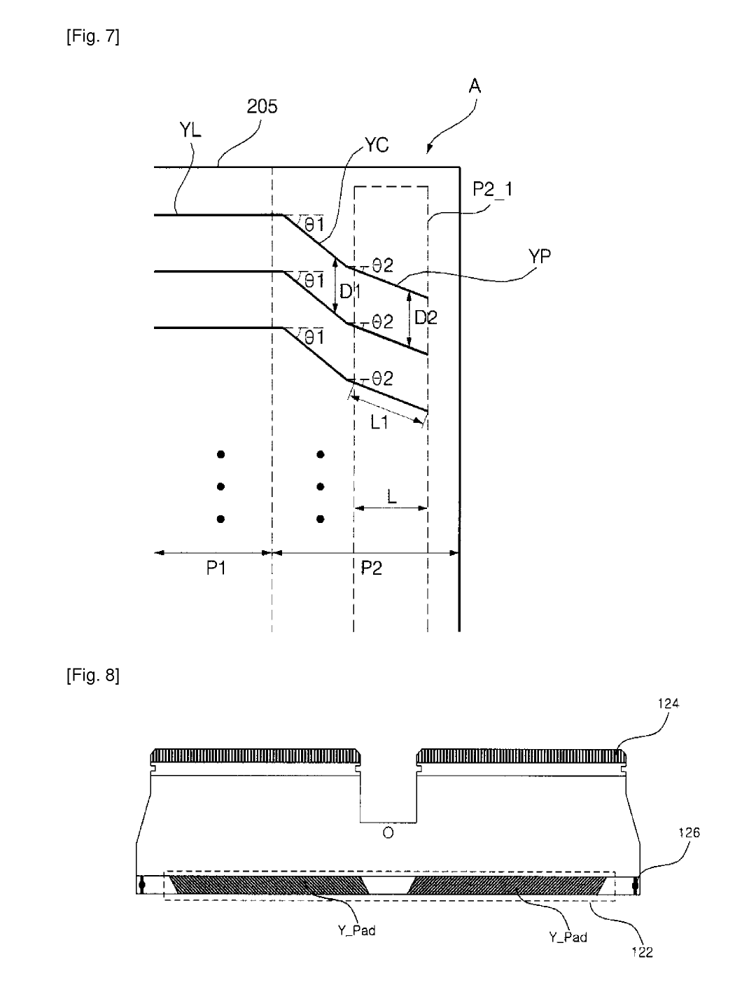

FIG. 7 is a plan view showing a region ‘A’ illustrated in FIG. 6. FIG. 7 illustrates scan electrodes Y among the plurality of electrodes formed on the plasma display panel. Although only the scan electrodes Y are shown in FIG. 7, the sustain electrodes and the address electrodes can substitute for the scan electrodes Y.

Referring to FIG. 7, a plurality of scan electrodes Y are formed on the upper substrate 205. The scan electrodes Y are formed on not only the effective area P1 but also the pad region P2 surrounding the effective area P1.

At least one of the scan electrodes Y may include a line electrode, a connecting electrode and a pad electrode. The line electrode, the connecting electrode and the pad electrode may have different gradients. In this case, at least one of the scan electrodes Y may include a line electrode YL extended in the horizontal direction, a connecting electrode YC extended from the line electrode YL and sloped from the line electrode YL having a first gradient θ1, and a pad electrode YP extended from the connecting electrode YC and sloped from a line parallel with the line electrode YL having a second gradient θ2. In the current embodiment of the invention, a gradient is based on the line electrode or a line parallel with the line electrode. That is, the gradient corresponds to an angle from the line electrode or the line parallel with the line electrode.

The line electrode YL is formed on the effective area P1 and generates discharge according to a driving voltage supplied from the connecting member (not shown). The connecting electrode YC is formed on the pad region P2, extended from the line electrode YL and sloped having the first gradient θ1 and may not generate discharge according to the driving voltage. Further, the pad electrode YP is extended from the connecting electrode YC and sloped from the line parallel with the line electrode YL having the second gradient θ2. The pad electrode YP is formed on a contact region P2_1 which electrically comes into contact with the connecting member on the pad region P2. Here, the length L1 of the pad electrode YP is greater than the length L of the shorter side of the contact region P2_1.

The line electrode YL and the pad electrode YP are formed in parallel with each other, in general. In this case, the shape of the connecting member electrically coming into contact with the pad electrode YP is restricted by the shape of the pad electrode YP, and thus the size of the connecting member may unnecessarily increase and the manufacturing cost may also increase.

Further, the length of the pad electrode YP tends to decrease as the size of the bezel or the pad region P2 decreases. Accordingly, the contact area of the pad electrode is reduced, and thus poor products may be produced and productivity may be deteriorated.

According to the current embodiment of the invention, the line electrode YL, the connecting electrode YC and the pad electrode YP may have different gradients, as illustrated in FIG. 7. That is, the line electrode YL and the pad electrode YP may not be parallel with each other and the second gradient θ2 may be smaller than the first gradient θ1. Accordingly, the pad electrode YP may be gently sloped from the line electrode YL.

Further, even if the width of the contact region P2_1 decreases, the pad electrode YP is formed having a gradient, and thus the contact area and contact length of the pad electrode YP increase, as compared to a case that the pad electrode is formed in parallel with the line electrode YL. Accordingly, poor products can be improved and productivity can be increased.

Here, the angle between the connecting electrode YC and the pad electrode YP may be in the range of 110° to 150°. The gradient θ2 of the pad electrode YP, that is, the angle between the pad electrode YP and the line parallel with the line electrode YL, may be in the range of 10° to 40°. This is for the purpose of maintaining a distance between neighboring line electrodes YL greater than a predetermined value even if the number of scan electrodes Y increases and preventing defects such as short-circuit generated during a process.

Further, the gradient θ2 of the pad electrode YP may be 30° in order to prevent the scan electrodes Y from short-circuiting during a patterning process.

Here, the length L1 of the pad electrode YP superposed on the contact region P2_1 can be calculated using the length L of the shorter side of the contact region P2_1 and the cosine function of the second gradient θ2. Accordingly, it can be easily known that the length L1 of the pad electrode YP can be greater than the length L of the shorter side of the contact region P2_1.

That is, in the plasma display device according to the present invention, the length of the pad electrode is greater than the width of the contact region connected with the connecting member.

Further, the contact area of the pad electrode corresponds to the product of the length of the pad electrode and the width of the pad electrode, and thus an increase in the contact length is proportional to an increase in the contact area.

Moreover, a distance D1 between connecting electrodes YC of two neighboring scan electrodes Y may be identical to or narrower than a distance D2 between pad electrodes YP of the two neighboring scan electrodes Y. This is because the second gradient θ2 can be identical to or smaller than the first gradient θ1 for preparing for a increase in the width of the pad electrode.

Further, the scan electrodes Y are symmetrically arranged based on the center. If the scan electrodes Y are divided into a plurality of blocks, scan electrodes of each block can be symmetrically formed.

Though FIG. 7 illustrates that the plurality of pad electrodes YP have the same length L1, at least two of the plurality of pad electrodes may have different lengths. Further, at least two pad electrodes may have different second gradients θ2 and different widths.

That is, the widths of some of the pad electrodes may be widened in order to increase the contact area. Further, if there is a large difference among the gradients of the pad electrodes or connecting electrodes of the plurality of scan electrodes, a length difference among the pad electrodes or connecting electrodes may be generated because the electrodes are required to be formed in a predetermined area. In this case, the lengths of the connecting electrodes or pad electrodes may be varied to reduce a difference among line resistances of the electrodes so as to compensate for a line resistance difference.

FIG. 8 is a view showing a configuration of a connecting member coming into contact with a scan electrode illustrated in FIG. 7 according to an embodiment of the present invention. FIG. 8 roughly illustrates the connecting member (FPC) connecting the PCB illustrated in FIG. 5 and the scan electrodes Y.

Referring to FIG. 8, the connecting member (FPC) includes a first connecting part 122 in which pad electrodes Y_Pad electrically connected with the scan electrodes Y are formed, a second connecting part 124 connected with a connector of the PCB generating a driving voltage, and an alignment mark 126 for aligning the scan electrodes Y and the pad electrodes Y_Pad such that the scan electrodes Y correctly come into contact with the pad electrodes Y_Pad.

The second connecting part 124 of the connecting member (FPC) according to the present invention may be directly bonded to the PCB without using an additional connector. For example, the connecting member may be bonded to the PCB using an anisotropic conductive film (ACF). The ACF is an adhesive material having bidirectional insulation and conductivity in the thickness direction and corresponds to a tape on which conductive particles are dispersed.

The ACF can be placed between the connecting member and the PCB and heated or pressed to fix the connecting member onto the PCB and, simultaneously, electrically connect the connecting member with the PCB.

The first connecting part 122 is formed such that the pad electrodes Y_Pad are sloped having the second gradient θ2 to be overlapped with the pad electrodes YP of the scan electrodes Y. Accordingly, the size of the connecting member (FPC) can be reduced to smaller than the connecting member shown in FIG. 8 because the alignment mark 126 can be formed in close proximity to the first connecting part 122.

In the plasma display device according to the present invention, the scan electrodes and the pad electrodes are formed having predetermined angles, and thus the contact area of electrodes can be increased to cope with a reduction of the pad region, that is, the contact region, due to the bezel. Accordingly, horizontal flickering can be prevented.

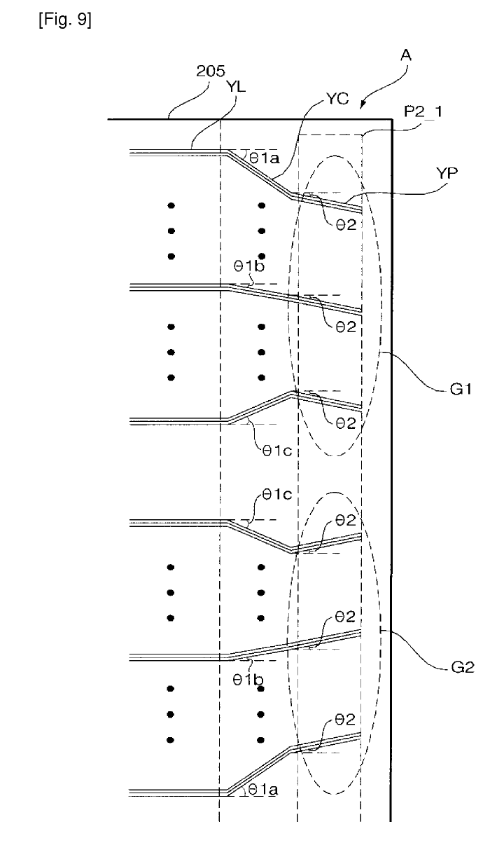

FIG. 9 illustrates a plasma display device according to an embodiment of the present invention.

While FIG. 7 illustrates that the connecting electrodes YC have the same gradient θ1 and the pad electrodes YP have the same gradient θ2, FIG. 9 illustrates that the connecting electrodes YC have different gradients. Further, electrodes G1 of a first group and electrodes G2 of a second group are symmetrically arranged.

In general, a plurality of scan electrodes are connected to multiple connecting members. Accordingly, a problem such as uneven luminance may generate due to a temperature variation according to positions of the scan electrodes in the entire area from the top and bottom of the panel and use of the scan electrodes. However, the present invention can provide most suitable electrode shapes without changing the electrodes of the effective area.

Referring to FIG. 9, the connecting electrodes YC may have different lengths if the connecting electrodes YC have different gradients θ1a, θ1b and θ1c. If the scan electrodes Y have different lengths, the scan electrodes Y have different line resistances, which means that luminances of lines can be independently controlled.

Accordingly, a luminance difference between lines can be corrected by forming connecting electrodes or pad electrodes having different gradients.

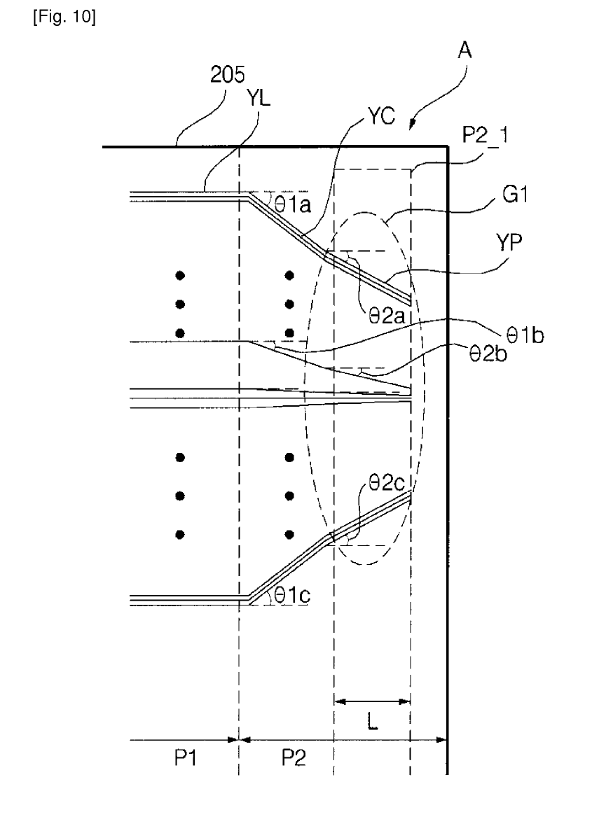

FIG. 10 illustrates a plasma display device according to another embodiment of the present invention.

Referring to FIG. 10, the connecting electrodes YC have different gradients θ1a, θ1b and θ1c and the pad electrodes YP also have different gradients θ2a, θ2b and θ2c.

That is, the plasma display device according to the current embodiment of the invention includes a plasma display panel on which a plurality of electrodes are formed. The plurality of electrodes respectively include line electrodes YL, connecting electrodes YC and pad electrodes YP, and the gradient of the pad electrode of a first electrode of the plurality of electrodes is different from the gradient of the pad electrode of a second electrode of the plurality of electrodes.

The connecting electrodes YC and the pad electrodes YP can be designed such that they have various gradients and lengths, and thus the plurality of electrodes can have various line resistances and the line resistances can be corrected in various manners, as compared to the embodiment illustrated in FIG. 9. Further, the plurality of electrodes can be arranged in a symmetrical manner to simplify the manufacturing process.

Specifically, pad electrodes of electrodes belonging to a first group, which are connected to a single connecting member, among the plurality of electrodes can be formed in such a manner that upper and lower pad electrodes are symmetrical. In this case, the gradients θ2a and θ2c of the pad electrodes are equal to each other.

Further, the gradient θ2b may be smaller than the gradient θ2a, as illustrated in FIG. 10. That is, the angle between a line parallel with the line electrode YL and the pad electrode YP located at the center of the panel may be smaller than the angle between the parallel line and the pad electrode YP located in the marginal region of the panel. Further, the pad electrode located at the center among the electrodes belonging to the first group, which are connected to the single connecting member, may have a smallest gradient. In this case, the pad electrode located at the center may have a gradient of 0°.

Moreover, the line electrode, the connecting electrode and the pad electrode of at least one of the first and second electrodes may have different gradients, as described above with reference to FIG. 7. Explanations of parts which have been described above are omitted. That is, the embodiments of the present invention explained above with reference to the attached drawings can be independently performed or combined and carried out.

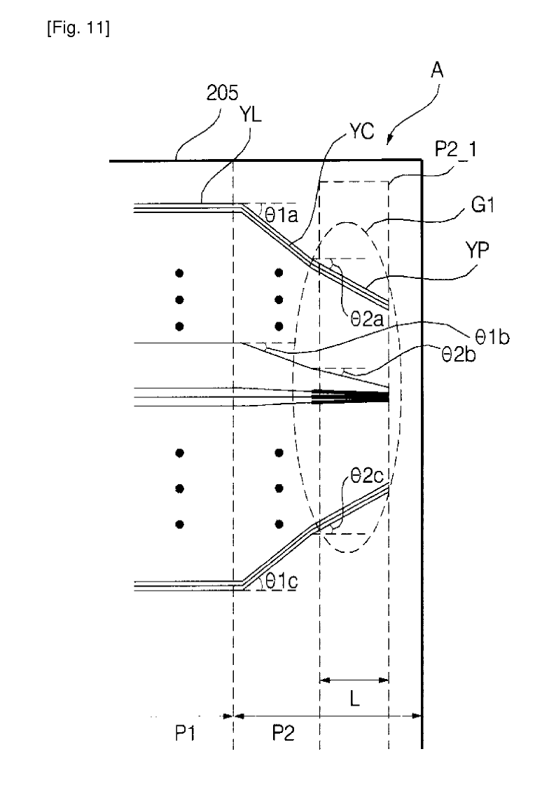

FIG. 11 illustrates a plasma display device according to another embodiment of the present invention.

Referring to FIG. 11, pad electrodes of at least two electrodes of the plurality of electrodes may have different widths. In this case, the pad electrode of the electrode located at the center among electrodes of a first group, which are connected to a single connecting member, may have a largest width. This can increase the contact area. Further, the length of the scan electrode located at the center may be greater than the lengths of other scan electrodes, and thus a line resistance difference between lines can be corrected. In addition, the connecting electrodes may have different widths.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display device comprising a plasma display panel on which a plurality of electrodes are formed,
wherein at least one of the plurality of electrodes includes a line electrode, a connecting electrode and a pad electrode,
and the line electrode, the connecting electrode and the pad electrode have different gradients.

2. The plasma display device of claim 1, wherein the line electrode is extended in the horizontal direction,
the connecting electrode is extended from the line electrode and sloped having a first gradient, and the pad electrode is extended from the connecting electrode and sloped having a second gradient from a line parallel with the line electrode.

3. The plasma display device of claim 2, wherein the second gradient is smaller than the first gradient.

4. The plasma display device of claim 2, wherein the second gradient has an angle in the range of 10° to 40° from the line parallel with the line electrode.

5. The plasma display device of claim 1, wherein a distance between connecting electrodes of two neighboring electrodes among the plurality of electrodes is identical to or smaller than a distance between pad electrodes of the two neighboring electrodes.

6. The plasma display device of claim 1, wherein the plurality of electrodes are divided into a first electrode group formed in a first block and a second electrode group formed in a second block, and the first electrode group and the second electrode group are symmetrically arranged.

7. The plasma display device of claim 1, further comprising a connecting member electrically coming into contact with the plurality of electrodes, wherein the connecting member includes an electrode pattern having the second gradient and overlapped with the pad electrodes.

8. The plasma display device of claim 1, wherein pad electrodes of at least two of the plurality of electrodes have different gradients.

9. The plasma display device of claim 1, wherein pad electrodes of at least two of the plurality of electrodes have different lengths.

10. The plasma display device of claim 1, wherein pad electrodes of at least two of the plurality of electrodes have different widths.

11. A plasma display device comprising a plasma display panel on which a plurality of electrodes are formed,
wherein the plurality of electrodes respectively include line electrodes, connecting electrodes and pad electrodes, and pad electrodes of first and second electrodes among the plurality of electrodes have different gradients.

12. The plasma display device of claim 11, wherein pad electrodes of electrodes of a first group, which are connected to a single connecting member among the plurality of electrodes, are arranged symmetrically based on the center of the first group.

13. The plasma display device of claim 11, wherein the pad electrode of the electrode located at the center among the electrodes of the first group, which are connected to the single connecting member, has a smallest gradient.

14. The plasma display device of claim 11, wherein pad electrodes of at least two of the plurality of electrodes have different widths.

15. The plasma display device of claim 11, wherein the pad electrode of the electrode located at the center among the electrodes of the first group, which are connected to the single connecting member, has a largest width.

16. The plasma display device of claim 11, wherein the line electrode, the connecting electrode and the pad electrode of at least one of the first and second electrodes have different gradients.

17. The plasma display device of claim 16, wherein the line electrode of at least one of the first and second electrodes is extended in the horizontal direction, the connecting electrode of the at least one of the first and second electrodes is extended from the line electrode and sloped having a first gradient, and the pad electrode of the at least one of the first and second electrodes is extended from the connecting electrode and sloped having a second gradient from a line parallel with the line electrode.

18. The plasma display device of claim 17, wherein the second gradient is smaller than the first gradient.

19. The plasma display device of claim 17, wherein the second gradient has an angle in the range of 10° to 40° from the line parallel with the line electrode.

20. A plasma display device comprising a plasma display panel on which a plurality of electrodes are formed,
wherein at least one of the plurality of electrodes includes a line electrode, a connecting electrode and a pad electrode, and the length of the pad electrode is greater than the width of a contact region connected to a connecting member.
